(19) United States
(12) Patent Application Publication
(10) Pub. No.: US 2008/0011741 A1
(43) Pub. Date: Jan. 17, 2008

(54) INDUCTIVE HEATING ELEMENT

(75) Inventors: Maki HAMAGUCHI, Kobe-shi (JP); Takayasu Fujiura, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/773,075

(22) Filed: Jul. 3, 2007

(30) Foreign Application Priority Data
Jul. 11, 2006 (JP) 2006-190473

(51) Int. Cl. H05B 6/00; H05B 6/02; H05B 6/10

(52) U.S. Cl. 219/642; 219/600; 219/651

(57) ABSTRACT

An inductive heating element includes a substrate and an insulating layer covering the substrate. The substrate contains a carbonaceous material such as glassy carbon. The inductive heating element effectively exchanges heat with a flowing gas to be heated and thereby efficiently heat the gas.

### BACKGROUND OF THE INVENTION

1. Field of the Invention

The present invention relates to inductive heating elements for use in gas heating systems for inductively heating gasses and other substances in processes for fabricating semiconductor devices.

2. Description of the Related Art

According to induction heating, an article to be heated (herein after also briefly referred to as “target”) is heated in the following manner. An induced current occurs in an electroconductive heating element by the action of a high-frequency coil, the induced current makes the heating element to liberate Joule's heat, and the Joule's heat elevates the temperature of the target. When the target is a gas such as water vapor (steam), air, or a hydrocarbon gas, the gas is allowed to flow through a heating system including the heating element.

Systems for heating gases using the induction heating should satisfy following conditions (a), (b), and (c):

(a) the systems can efficiently carry out induction heating (high induction heating efficiency);

(b) the heating elements can efficiently heat a gas, namely, the heating elements as solids can exchange heat with the target gas (high heat exchange effectiveness); and

(c) the heating elements neither contaminate the target gas nor are damaged as a result of reaction with target gas.

The condition (a) (high inductive heating efficiency) is important in all inductive heating techniques, regardless of the state of target (gas, solid, or liquid).

In consideration only of the efficiency of inductive heating, heating elements may generally be formed from electroconductive materials such as metals and carbonaceous materials, and heating systems should be designed to yield optimal output (power) and frequency in high-frequency power.

The condition (c) is important in some species of gases. If the target gas is, for example, a corrosive gas, and the heating element is made of a metal, the metal may be corroded. If the heating element is made of a regular carbonaceous material such as graphite, the heating element is susceptible to powdering, and the target gas may be contaminated with the resulting powder of the heating element.

From these viewpoints, glassy carbon is desirable as a material for heating elements, because it is chemically stable and highly resistant to powdering.

For example, Japanese Unexamined Patent Application Publication (JP-A) No. 2003-151737 discloses an inductive heating system. The system includes a reactor, a glassy carbon cylinder arranged in the reactor, and a high-frequency induction coil surrounding the reactor. The high-frequency induction coil makes the glassy carbon cylinder in the reactor to liberate heat so as to heat a target, such as a silicon wafer, in the reactor.

The design of heating elements is a key factor for higher heat exchange effectiveness (b), as for the high inductive heating efficiency (a).

### SUMMARY OF THE INVENTION

The heat exchange effectiveness between a heating element and a gas generally increases with an increasing surface are a of the heating element. However, it is difficult to increase both the inductive heating efficiency and the heat exchange effectiveness concurrently. This is because an induced current undergoes skin effect and may not always pass through (heat) the entire heating element.

A heating system may be taken as an example, which has a heating element including a cylindrical solid body and through holes penetrating the cylindrical solid body in an axial direction of the cylindrical body. In this system, a high-frequency induction coil is arranged so as to surround the outer peripheral side of the cylindrical heating element, and a target gas is allowed to flow around the heating element and in the through holes.

The heating element having this configuration can have an increased surface are a by arranging through holes. However, the induced current passes through and heats only the outer surface of the heating element but does not pass through and heat the inner walls and the vicinities thereof of the through holes, due to the skin effect.

Consequently, the target gas is heated only where it is in contact with the outer periphery of the heating element, and the through holes do not effectively contribute to heating of the gas.

Under these circumstances in known inductive heating systems, it is desirable to provide an inductive heating element which can effectively exchange heat with a target gas and efficiently heat the target gas.

Specifically, according to an embodiment of the present invention, there is provided an inductive heating element containing a substrate composed of a carbonaceous material, and an insulating layer covering the substrate.

The inductive heating element according to an embodiment of the present invention contains a substrate composed of a carbonaceous material, and an insulating layer covering the substrate. Even when a plurality of such inductive heating elements are arranged to be in contact with each other, they are not electrically connected with each other. Accordingly, they are resistant to skin effect due to leakage current and can thereby maintain their heating efficiency at certain level. In addition, even if inductive heating elements come in contact with each other intermittently, they may not undergo discharging and thereby may not be consumed or worn due to discharging.

The carbonaceous material in the inductive heating element is preferably glassy carbon.

An inductive heating element including a substrate composed of glassy carbon may be more chemically stable and more resistant to powdering than an inductive heating element using another carbonaceous material such as graphite.

The insulating layer in the inductive heating element may include one or more known insulating materials. Examples of such insulating materials include ceramics such as silicon carbide, silicon nitride, alumina, silicon dioxide, and magnesia.

Among them, silicon dioxide and silicon carbide are desirable, because an insulating layer mainly including silicon dioxide and/or silicon carbide is further thermally stable and is further insulative.

An inductive heating element according to an embodiment of the present invention can be spherical.

An inductive heating element according to another embodiment of the present invention may have a hollow structure including a core cavity and a wall surrounding the core cavity, and may further include at least one hole penetrating the wall and communicating with the core cavity. When the target to be heated is a fluid such as a gas, this inductive heating element can have a further increased heat exchange effectiveness, because the target fluid can also pass through the inside (core cavity) of the inductive heating element.

An inductive heating element having an insulating layer according to an embodiment of the present invention has an increased surface are a per volume of heating space. Consequently, it can heat a target gas highly efficiently with an increased heat exchange effectiveness.

### BRIEF DESCRIPTION OF THE DRAWINGS

FIG. 1 is a cross-sectional view illustrating a structure of an inductive heating element according to an embodiment of the present invention; and

FIG. 2 is a block diagram illustrating a configuration of a flow gas heating system to which an inductive heating element according to an embodiment of the present invention is applied.

### DESCRIPTION OF THE PREFERRED EMBODIMENTS

Some embodiments of the present invention will be illustrated in detail with reference to the attached drawings.

1. Inductive Heating Element

Such an inductive heating element having an insulating layer as its outermost layer can be prepared, for example, by forming an insulating layer on a molded carbonaceous article as the substrate.

Examples of carbonaceous materials for use in the substrate include graphite and glassy carbon. The substrate for heating element can be prepared by machining any available molded carbonaceous article into a desired shape of heating element.

The insulating layer can be formed, for example, by depositing silicon carbide on the substrate through chemical vapor deposition (CVD) or by applying a ceramic precursor polymer to the substrate and heating the substrate together with the applied layer to thereby yield a ceramic layer on the substrate.

The thickness of the insulating layer is not specifically limited, but is preferably 1 μm or more so as to prevent the delamination of the insulating layer even when inductive heating elements come in contact with each other.

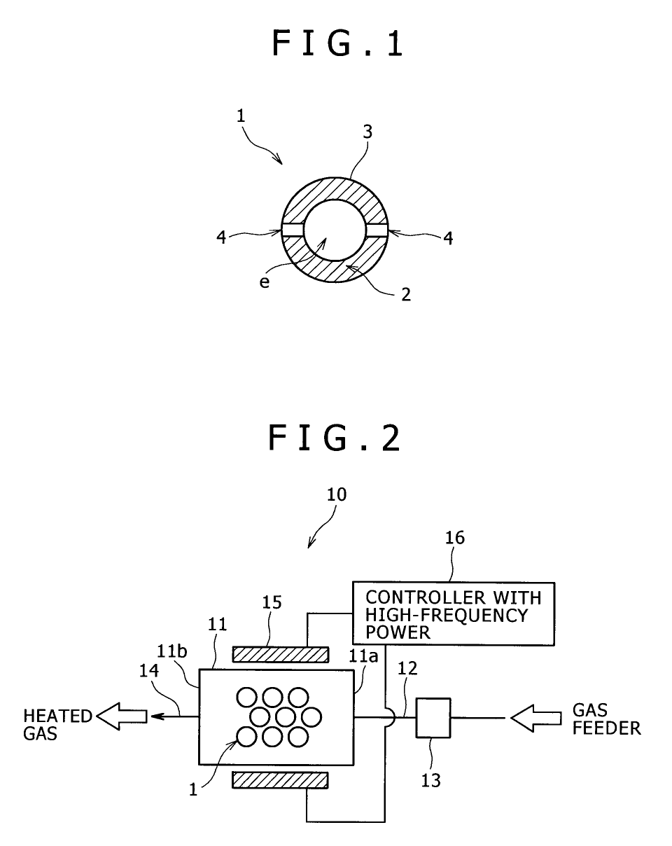

FIG. 1 is a cross-sectional view illustrating an inductive heating element according to an embodiment of the present invention.

An inductive heating element 1 in FIG. 1 includes a hollow spherical substrate 2 and an insulating layer 3 covering an outer surface of the substrate 2. The substrate 2 is composed of glassy carbon and includes core cavity “e”.

The inductive heating element 1 has at least one through hole 4. When the inductive heating element 1 has two or more through holes 4, it has a further higher heating efficiency, because a target gas can also pass through the core cavity “e” of the inductive heating element 1.

In addition, hollowing the inductive heating element 1 saves a material for the inductive heating element. Namely, it increases the use efficiency of the material. This is because if an inductive heating element is formed into a solid sphere, the inside of the inductive heating element does not liberate heat and does not contribute to heat exchange upon inductive heating, due to skin effect.

Hollowing the inductive heating element 1 to form a core cavity and arranging at least one through hole 4 is effective for preventing damage of the inductive heating element 1. This is because, if an inductive heating element having a closed core cavity is heated, the pressure inside the core cavity may vary, and this may damage the inductive heating element.

A substrate composed of glassy carbon may have poor adhesion with an insulating layer. In this case, good adhesion between the substrate and the insulating layer may be obtained, for example, by applying a layer of a material for insulating layer to a molded resinous article as a precursor of glassy carbon, and subjecting the molded resinous article and the applied layer to heat treatment to thereby convert the molded resinous article to glassy carbon and convert the applied layer to an insulating layer simultaneously.

Next, a flow gas heating system using the inductive heating element 1 having the insulating layer 3 will be illustrated.

Some inductive heating systems use susceptors composed of glassy carbon. In these systems, one disc-like susceptor or one cylindrical susceptor is arranged in a heating chamber; a target is placed on the disc-like susceptor or in the cylindrical susceptor; the disc-like susceptor or cylindrical susceptor is heated to liberate radiant heat; and the target is indirectly heated by the radiant heat. The “susceptor” herein means a member or material that liberates heat upon application of energy from a high-frequency magnetic field.

Inductive heating systems of this type are intended to heat solids such as silicon wafers and have insufficient heating efficiencies when the target is a fluid which moves at a high space velocity.

This is because, for example, the susceptor has a relatively insufficient volume to thereby fail to allow a large induced current to pass through the susceptor. This causes an insufficient power (output). In addition, the one disc-like susceptor or one cylindrical susceptor has a limited surface are a and fails to have a high heat exchange effectiveness with a fluid passing therethrough.

Consequently, attempts have been made to improve susceptors. For example, the volume and/or thickness of a known disc-like susceptor or cylindrical susceptor has been increased. However, the present inventors have found that it is difficult to increase the heating efficiency of a fluid by improving such a known configuration.

This is probably because, even if a susceptor is merely upsized, the skin effect makes it difficult to allow the inside of the susceptor to liberate heat, and the susceptor may not have an increased surface are a per volume of the susceptor. Due to the skin effect, an induced current induced into a target predominantly localizes on the surface of the target and significantly decreases with an increasing depth from the surface.

In contrast, a flow gas heating system for use in an embodiment of the present invention has a quite different configuration from those of known susceptors. More specifically, the flow gas heating system includes plural independent inductive heating elements 1 housed in a casing. These inductive heating elements 1 serve as susceptors.

2. Flow Gas Heating System

FIG. 2 is a block diagram showing a basic configuration of a flow gas heating system to which an inductive heating element according to an embodiment of the present invention is applied.

A flow gas heating system 10 in FIG. 2 includes a tubular heating element casing (chamber) 11 made of quartz, and plural carbonaceous inductive heating elements 1 each having an insulating layer housed in the heating element casing 11. The heating element casing 11 provides a space for housing the inductive heating elements 1. The carbonaceous inductive heating elements 1 housed in the heating element casing 11 serve as susceptors.

The heating element casing 11 has one end 11a and the other end 11b. These ends are each releasably closed with a stopper such as a rubber plug having a through hole.

The one end 11a is connected to an inlet tube 12 for introducing a target gas. The inlet tube 12 is connected through a flow-rate adjustor 13 to a gas feeder (gas feeding device; not shown). The flow-rate adjustor 13 adjusts the flow rate of the target gas.

The gas feeder can be, for example, a gas cylinder containing nitrogen gas. When the gas is liquid at ordinary temperature (room temperature), such as chlorine trifluoride (ClF₃), the gas feeder may further include a vaporizer.

An outlet tube 14 for discharging the heated target gas is connected to the other end 11b.

An induction coil (high-frequency coil) 15 is helically wound around the heating element casing 11. The induction coil 15 is connected to a controller 16 equipped with a high-frequency alternating-current power supply.

The flow gas heating system 10 is configured as follows. The carbonaceous inductive heating elements 1 are allowed to liberate heat as Joule's heat by the action of an induced current, and a target gas is fed into the heating element casing 11 in this state. Heat exchange is conducted between the carbonaceous inductive heating elements 1 and the target gas to thereby heat the target gas to a desired temperature, and the heated target gas is discharged from the outlet tube 14 at the other end 11b.

Next, a method for fabricating glassy carbon inductive heating elements will be illustrated.

### EXAMPLE 1

1-1. Fabrication of Inductive Heating Elements Composed of Glassy Carbon

Inductive heating elements composed of glassy carbon were fabricated in the following manner using a commercially available liquid phenolic resin (supplied from Gunei Chemical Industry Co., Ltd. under the trade name of PL-4804) as a material.

Initially, the resin was placed into a mold having a semi-spherical cavity with a radius of 15 mm and was held at 80° C. for twenty hours to semi-cure the resin, followed by removing the mold. Thus, a solid semi-spherical molded phenolic resin article having a radius of 15 mm was obtained.

Next, the molded article was hollowed to form a semispherical cavity having a radius of 12 mm concentrically with the outer periphery of the molded article. Thus, a semispherical hollow molded phenolic resin article having an outer diameter of 30 mm and a wall thickness of 3 mm was obtained.

Two semispherical hollow molded phenolic resin articles fabricated as above were pasted with each other at their equatorial planes with an adhesive containing the same resin with the phenolic resin, were heated at 80° C. for two hours to cure the resin, and thereby yielded a spherical hollow molded article.

A total of two gas vent holes each having a diameter of 10 mm were formed at the two poles of the spherical hollow molded article.

The spherical hollow molded article having the holes was raised in temperature at a rate of 5° C. per hour to 1000° C. in a nitrogen atmosphere to convert the article into glassy carbon.

As a result, a hollow spherical inductive heating element composed of glassy carbon having an outer diameter of 25 mm and a wall thickness of 2.5 mm was fabricated.

1-2. Formation of Insulating Layer

An insulating layer was formed using a silica coating agent supplied from Clariant Japan Co., Ltd. under the trade name of ALCEDAR COAT as a material.

The outer surface of the glassy carbon inductive heating element fabricated as above was filed and thereby roughed with a sandpaper #400, and a 5 percent by weight solution of ALCEDAR COAT in xylene was applied to the roughened surface.

The applied layer was heated to 150° C. to thereby remove the solvent and dry the layer, followed by heating at 400° C. in the atmosphere to bake the layer.

The resulting silica layer (coating layer) had a thickness of about 5 μm.

1-3. Configuration of Flow Gas Heating System for Heating Steam as Target Gas

A quartz tube having an inner diameter of 70 mm and a length of 150 mm was used as a heating element casing for providing a space for housing carbonaceous inductive heating elements.

Fifteen glassy carbon inductive heating elements each having the insulating layer fabricated as above were placed in the inner space of the quartz tube.

A pipe for introducing steam and a flow-rate control valve were connected to one end of the quartz tube, and a pipe for discharging heated steam was connected to the other end.

A high-frequency induction coil was wound to a diameter of 100 mm at a pitch of 15 mm seven times around the quartz tube. The high-frequency induction coil acts to allow the glassy carbon inductive heating elements to liberate heat.

A high-frequency power supply and a controller for controlling the power supply were connected to the high-frequency induction coil.

1-4. Heating Test

A high-frequency power was applied to the high-frequency induction coil at a frequency of 430 kHz, an output of 1.2 kW, and a current of 6 amperes while steam at a temperature of 150° C. was allowed to pass through the flow gas heating system at a rate in terms of water of 10 grams per minute (at a flow rate of steam of 19 litters per minute).

The steam temperature at the outlet of the heating element casing was 350° C., indicating that the steam temperature was elevated through heating by 200° C.

### COMPARATIVE EXAMPLE 1

A flow gas heating system was manufactured by the procedure of Example 1, except for using glassy carbon inductive heating elements having no insulating layer, and steam was heated using the system under the condition of Example 1. The steam temperature at the outlet of the heating element casing was 250° C., indicating that the steam temperature was elevated through heating only by 100° C.

### EXAMPLE 2

A spherical part having an outer diameter 25 mm was cut from a commercially available isotropic graphite material, and a silica layer about 5 μm thick was applied to the spherical part by the procedure of Example 1.

A steam heating test was conducted using the same flow gas heating system under the same condition as Example 1, except for using the spherical part having an insulating layer. The steam temperature at the outlet of the heating element casing was 325° C., indicating that the steam temperature was elevated through heating by 175° C.

### COMPARATIVE EXAMPLE 2

A steam heating test was conducted using the same flow gas heating system under the same condition as Example 1 and using the same graphite heating elements as Example 2, except that the graphite heating elements had no silica coating. The steam temperature at the outlet of the heating element casing was 210° C., indicating that the steam temperature was elevated through heating only by 60° C.

In addition, a small amount of graphite fine power was observed on the surfaces of graphite heating elements.

It should be understood by those skilled in the art that various modifications, combinations, sub-combinations, and alternations may occur depending on the design requirements and other factors insofar as they are within the scope and spirit of the appended claims or the equivalents thereof.

What is claimed is:

1. An inductive heating element comprising:
a substrate containing a carbonaceous material; and
an insulating layer covering the substrate.

2. The inductive heating element according to claim 1, wherein the carbonaceous material is glassy carbon.

3. The inductive heating element according to claim 1, wherein the insulating layer comprises a ceramic.

4. The inductive heating element according to claim 2, wherein the insulating layer comprises a ceramic.

5. The inductive heating element according to claim 1, wherein the inductive heating element is substantially spherical.

6. The inductive heating element according to claim 4, wherein the inductive heating element is substantially spherical.

7. The inductive heating element according to claim 1, wherein the inductive heating element has a hollow structure including a core cavity and a wall surrounding the core cavity, and wherein the inductive heating element further comprises at least one through hole penetrating the wall and communicating with the core cavity.

8. The inductive heating element according to claim 6, wherein the inductive heating element has a hollow structure including a core cavity and a wall surrounding the core cavity, and wherein the inductive heating element further comprises at least one through hole penetrating the wall and communicating with the core cavity.
